(19) United States
(12) Patent Application Publication
(10) Pub. No.: US 2013/0000807 A1
(43) Pub. Date: Jan. 3, 2013

(54) ANTI-SKID STUD FOR INSERTION INTO THE TREAD OF A VEHICLE TIRE AND PNEUMATIC TIRE COMPRISING SUCH ANTI-SKID STUDS

(76) Inventors: Frederic Michel-Jean Pons, Thionville (FR); Sebastien Willy Fontaine, Vichten (LU); Jerome Marcel Germain Delu, Bridel (LU)

(21) Appl. No.: 13/170,452

(22) Filed: Jun. 28, 2011

(51) Int. Cl. B60C 11/14

(52) U.S. Cl. 152/210; 152/208

(57) ABSTRACT

An anti-skid stud for insertion into the tread of a vehicle tire is disclosed. The stud comprises a support body part extending in an axial direction and a pin body part, the support body part comprising a bottom portion, a middle portion, and a head portion having an upper surface, wherein the pin body part extends beyond the upper surface of the head portion, and wherein, when viewed in top view onto the head portion,
(i) the location of the center of gravity of the head portion is laterally offset from the center of gravity of the bottom portion; or
(ii) the location of the center of gravity of the pin body part is laterally offset from the center of gravity of the bottom portion; or
(iii) the location of the center of gravity of the pin body part is laterally offset from the center of gravity of the head portion; or
(iv) the location of the center of gravity of the middle portion is laterally offset from the center of gravity of the bottom portion.

Also, a pneumatic tire comprising a tread, the tread comprising a plurality of such anti-skid studs is disclosed. The majority of the studs may be oriented in a common direction.

### FIELD OF THE INVENTION

The present invention relates to an anti-skid stud for insertion into the tread of a vehicle tire, and to a pneumatic tire having a tread comprising a plurality of such anti-skid studs. The majority of the anti-skid studs may be oriented in a common direction in the tire tread.

### BACKGROUND OF THE INVENTION

Anti-skid studs for use in the treads of pneumatic tires are known for a long time. Such studs are axially symmetric along an axis extending along the length of the stud. An example for such a stud is described in WO 2011/036050 A1. A further example of a stud is described in US 2011/0088822 A1.

Studs may consist of a support body part made from aluminum or steel and one or more hard ceramic or hard metal pin body parts inserted into the upper end of the support body part. The design of anti-skid studs is limited in a number of ways in regulations in Sweden, Finland, or other countries in which the use of such studs is allowed. These regulations limit the mass of the studs, the stud pin protrusion above the tread surface, and the number and distribution of the studs over the tread surface for instance.

A challenge is presented to provide an anti-skid stud for pneumatic tires which provides improved grip on snow and in particular on ice compared to conventional studs but which nevertheless complies with regulations in Finland or Sweden for example.

A challenge is also presented to provide an anti-skid stud for pneumatic tires with at least the same or even improved stud retention properties compared to conventional studs.

Stud retention may be measured using the force needed to extract the stud from the tire tread. Stud retention may also be measured by the number of studs ejected from the tire tread after a given travelling distance of a vehicle equipped with the studded tire on snow and ice on a test course following a predefined speed and acceleration/braking pattern.

A challenge is also presented to provide an improved anti-skid stud for pneumatic tires which may be mounted using conventional studding machines.

### SUMMARY OF THE INVENTION

The present invention relates to an anti-skid stud for insertion into the tread or the use with the tread of a vehicle tire, the stud comprising a support body part extending in an axial direction and a pin body part, the support body part comprising a bottom portion, a middle portion, and a head portion having an upper surface, wherein the pin body part extends beyond the upper surface of the head portion, wherein, when viewed in top view onto the head portion,
(i) the location of the center of gravity of the head portion is laterally offset from the center of gravity of the bottom portion; or
(ii) the location of the center of gravity of the pin body part is laterally offset from the center of gravity of the bottom portion; or
(iii) the location of the center of gravity of the pin body part is laterally offset from the center of gravity of the head portion; or
(iv) the location of the center of gravity of the middle portion is laterally offset from the center of gravity of the bottom portion.

In one example of the present invention, the location of the center of gravity of the head portion is laterally offset from the center of gravity of the bottom portion and the location of the center of gravity of the pin body part is laterally offset from the center of gravity of the bottom portion.

In still another example of the present invention, the location of the center of gravity of the head portion is laterally offset from the center of gravity of the bottom portion and the location of the center of gravity of the pin body part is laterally offset from the center of gravity of the head portion.

In yet another example of the present invention, the location of the center of gravity of the bottom portion is axially aligned with the center of gravity of the middle portion.

In still another example of the present invention, the location of the center of gravity of the head portion is laterally offset from the center of gravity of the bottom portion and the location of the center of gravity of the middle portion is laterally offset from the center of gravity of the bottom portion.

In yet another example of the present invention, the location of the center of gravity of the head portion is laterally offset from the center of gravity of the bottom portion, the location of the center of gravity of the middle portion is laterally offset from the center of gravity of the bottom portion and the location of the center of gravity of the pin body part is laterally offset from the center of gravity of the head portion.

In still another example of the present invention, the location of the center of gravity of the head portion is laterally offset from the center of gravity of the bottom portion, the location of the center of gravity of the middle portion is laterally offset from the center of gravity of the bottom portion and the location of the center of gravity of the middle portion is laterally offset from the center of gravity of the bottom portion.

In yet another example of the present invention, the location of the center of gravity of the head portion is laterally offset from the center of gravity of the bottom portion, the location of the center of gravity of the middle portion is laterally offset from the center of gravity of the bottom portion, the location of the center of gravity of the middle portion is laterally offset from the center of gravity of the bottom portion and the location of the center of gravity of the middle portion is laterally offset from the center of gravity of the bottom portion.

In still another example of the present invention, the location of the center of gravity of the pin body part is laterally offset from the center of gravity of the bottom portion and the location of the center of gravity of the pin body part is laterally offset from the center of gravity of the head portion.

In yet another example of the present invention, the location of the center of gravity of the pin body part is laterally offset from the center of gravity of the bottom portion and the location of the center of gravity of the middle portion is laterally offset from the center of gravity of the bottom portion.

In still another example of the present invention, the location of the center of gravity of the pin body part is laterally offset from the center of gravity of the bottom portion, the location of the center of gravity of the pin body part is laterally offset from the center of gravity of the head portion and the location of the center of gravity of the middle portion is laterally offset from the center of gravity of the bottom portion.

In yet another example of the present invention, the location of the center of gravity of the pin body part is laterally offset from the center of gravity of the head portion and the location of the center of gravity of the middle portion is laterally offset from the center of gravity of the bottom portion.

In still another example of the present invention, the support body part comprises a receptacle wherein the pin body part is inserted into the receptacle and secured to the support body part via press fit.

In yet another example of the present invention, the bottom portion has, when viewed in top view onto the head portion:
(i) a substantially triangular shape with or without rounded edges;
(ii) a symmetrical substantially triangular shape with or without rounded edges;
(iii) an equilateral triangular shape with or without rounded edges;
(iv) a substantially hexagonal shape with or without rounded edges;
(v) a substantially hexagonal shape with alternating straight and segment shaped sides with or without rounded edges;
(vi) a substantially hexagonal shape with only straight sides with or without rounded edges;
(vii) a substantially hexagonal shape with only convex shaped sides with or without rounded edges;
(viii) a substantially hexagonal shape with only concave shaped sides with or without rounded edges; or
(ix) substantially hexagonal shape with alternating convex and concave shaped sides with or without rounded edges.

In still another example of the present invention, the middle portion has, when viewed in top view onto the head portion:
(i) a substantially triangular shape with or without rounded edges;
(ii) a symmetrical substantially triangular shape with or without rounded edges;
(iii) an equilateral triangular shape with or without rounded edges;
(iv) a substantially hexagonal shape with or without rounded edges;
(v) a substantially hexagonal shape with alternating straight and segment shaped sides with or without rounded edges;
(vi) a substantially hexagonal shape with only straight sides with or without rounded edges;
(vii) a substantially hexagonal shape with only convex shaped sides with or without rounded edges;
(viii) a substantially hexagonal shape with only concave shaped sides with or without rounded edges; or
(ix) a substantially hexagonal shape with alternating convex and concave shaped sides with or without rounded edges.

In yet another example of the present invention, the middle portion mimics, when viewed in top view onto the middle portion, the shape of the bottom portion at a reduced size or diameter.

In still another example of the present invention, the head portion has, when viewed in top view onto the head portion:
(i) a substantially triangular shape with or without rounded edges;
(ii) an isosceles triangular shape with or without rounded edges;
(iii) a substantially hexagonal shape with or without rounded edges;
(iv) a substantially hexagonal shape with alternating straight and segment shaped sides with or without rounded edges;
(v) a substantially hexagonal shape with only straight sides with or without rounded edges;
(vi) a substantially hexagonal shape with only convex shaped sides with or without rounded edges;
(vii) a substantially hexagonal shape with only concave shaped sides with or without rounded edges; or
(viii) a substantially hexagonal shape with alternating convex and concave shaped sides with or without rounded edges.

The convex shaped sides of the head portion may be longer, 10% to 40% longer, than the concave shaped sides.

In yet another example of the present invention, the head portion has, when viewed in top view onto the head portion, a substantially hexagonal shape with alternating convex and concave shaped sides with the two of the three convex shaped sides having the same length or about the same length and the third convex shaped side having a greater length, a 10% to 60% greater length, than the other two convex shaped sides. The concave shaped sides may have the same or about the same length. The concave shaped sides may be 10% to 30% shorter than the two convex shaped sides having the same length. The third convex shaped side may be located opposite the longest concave shaped side if the concave shaped sides have a different length.

In still another example of the present invention, the head portion has, when viewed in top view onto the head portion, a substantially hexagonal shape with alternating convex and concave shaped sides with the three concave shaped sides having the same length or about the same length.

In yet another example of the present invention, the head portion has, when viewed in top view onto the head portion, a substantially hexagonal shape with alternating convex and concave shaped sides with the three convex shaped sides having the same length or about the same length.

In still another example of the present invention, the head portion has, when viewed in top view onto the head portion, a substantially hexagonal shape with alternating convex and concave shaped sides with the two of the three concave shaped sides having the same length or about the same length and the third concave shaped side having a greater length, a 10% to 60% greater length, than the other two concave shaped sides. The convex shaped sides may have the same or about the same length. The convex shaped sides may be 10% to 30% shorter than the two concave shaped sides having the same length. The third concave shaped side may be located opposite the longest convex shaped side in case the convex shaped sides have a different length.

In yet another example of the present invention, the pin body part has, when viewed in top view onto the pin body part:
(i) substantially the shape of a sector of a circle with or without rounded edges;
(ii) substantially the shape of a lens with or without rounded edges;
(iii) substantially the shape of an aspherical lens or an axially symmetrical aspherical lens;
(iv) substantially the shape of a segment of an annulus with or without rounded edges;
(v) substantially the shape of a trapezium with or without rounded edges;
(vi) substantially the shape of a hexagon with or without rounded edges;
(vii) substantially the shape of a trapezium with or without rounded edges with alternating straight and concave shaped sides;
(viii) substantially the shape of a trapezium with or without rounded edges with alternating straight and convex shaped sides;
(ix) substantially the shape of a trapezium with or without rounded edges with alternating concave and convex shaped sides; or
(x) substantially the shape of a tetragon with or without rounded edges with straight, concave and convex shaped sides.

The lens may comprise an at least substantially convex side and an at least substantially concave opposite side.

In still another example of the present invention, the pin body part mimics at a reduced size or diameter, when viewed in top view onto the pin body part, the shape of the head portion.

In yet another example of the present invention, the support body part is made from aluminum or steel.

In still another example of the present invention, the pin body part is made from a hard ceramic material or a hard metal material.

In yet another example of the present invention, the surface area of the pin body part, when viewed in top view onto the pin body part, is in the range from 4.5 mm² to 7.0 mm², alternatively from 5.0 mm² to 6.5 mm².

In still another example of the present invention, the pin body part comprises a leading edge having a length in a range from 3.0 to 7.5 mm, alternatively from 3.0 to 5.5 mm or from 3.0 to 4.5 mm. The leading edge may be oriented perpendicular or at least substantially perpendicular to the rolling direction of the tire.

The leading edge is the edge of the pin body part which first comes into contact with the road when the tire is mounted on a vehicle and is rolling in a forward direction.

The present invention also relates to a pneumatic tire comprising a tread, the tread comprising a plurality of the anti-skid studs described above, i.e. the tread comprises a plurality of studs of which each comprises a support body part extending in an axial direction and a pin body part, the support body part comprising a bottom portion, a middle portion, and a head portion having an upper surface, wherein the pin body part extends beyond the upper surface of the head portion, wherein, when viewed in top view onto the head portion,
(i) the location of the center of gravity of the head portion is laterally offset from the center of gravity of the bottom portion; or
(ii) the location of the center of gravity of the pin body part is laterally offset from the center of gravity of the bottom portion; or
(iii) the location of the center of gravity of the pin body part is laterally offset from the center of gravity of the head portion; or
(iv) the location of the center of gravity of the middle portion is laterally offset from the center of gravity of the bottom portion.

The majority of the anti-skid studs or more than 70%, more than 90% or even all of the anti-skid studs may be oriented in a common direction.

The majority of the anti-skid studs or more than 70%, more than 90% or even all of the anti-skid studs may be oriented in a common direction with the leading edges being at least substantially oriented in a direction perpendicular to the rolling direction of the tire.

The present invention also relates to an anti-skid stud for insertion into the tread or the use with the tread of a vehicle tire, the stud comprising a support body part extending in an axial direction and a pin body part, the support body part comprising a bottom portion, a middle portion, and a head portion having an upper surface, wherein the pin body part extends beyond the upper surface of the head portion, and wherein, when rotating the support body part about an axis extending along the axial direction and through the center of gravity of the anti-skid stud, the rotated anti-skid stud is congruent with the respective unrotated anti-skid stud only when the anti-skid stud is rotated by 360 degrees. The present invention also relates to a pneumatic tire comprising a tread, the tread comprising a plurality of such anti-skid studs.

### BRIEF DESCRIPTION OF THE DRAWINGS

The present invention will be described by way of example and with reference to the accompanying drawings in which:

FIG. 1 is a perspective view of an anti-skid stud of a first embodiment of the invention;

FIG. 2 is a perspective view of an anti-skid stud of a second embodiment of the invention;

FIG. 3 is a perspective view of an anti-skid stud of a third embodiment of the invention;

FIG. 4 is a side view of the anti-skid stud in the first embodiment;

FIG. 5 is a side view of the anti-skid stud in the second embodiment;

FIG. 6 is a side view of the anti-skid stud in the third embodiment;

FIG. 7 is a top view onto the anti-skid stud of the first embodiment;

FIG. 8 is a top view onto the anti-skid stud of the second embodiment;

FIG. 9 is a top view onto the anti-skid stud of the third embodiment;

FIG. 10 is a perspective view from the bottom side of the anti-skid stud of the first embodiment;

FIG. 11 is a perspective view from the bottom side of the anti-skid stud of the second embodiment;

FIG. 12 is a perspective view from the bottom side of the anti-skid stud of the third embodiment;

FIG. 13 is a bottom view onto the anti-skid stud of the first embodiment;

FIG. 14 is a bottom view onto the anti-skid stud of the second embodiment;

FIG. 15 is a bottom view onto the anti-skid stud of the third embodiment;

FIG. 16 is a top view onto an anti-skid stud in a fourth embodiment of the invention;

FIG. 17 is a top view onto an anti-skid stud in a fifth embodiment of the invention;

FIG. 18 is a top view onto an anti-skid stud in a sixth embodiment of the invention;

FIG. 19 is a top view onto an anti-skid stud in a seventh embodiment of the invention;

FIG. 20 is a top view onto an anti-skid stud in an eight embodiment of the invention;

FIG. 21 is a top view onto an anti-skid stud in a ninth embodiment of the invention; and

FIG. 22 is a top view onto the anti-skid stud of the second embodiment (see FIG. 8) indicating the location of the centers of gravity of the various parts of the stud.

### DETAILED DESCRIPTION EXAMPLES OF THE PRESENT INVENTION

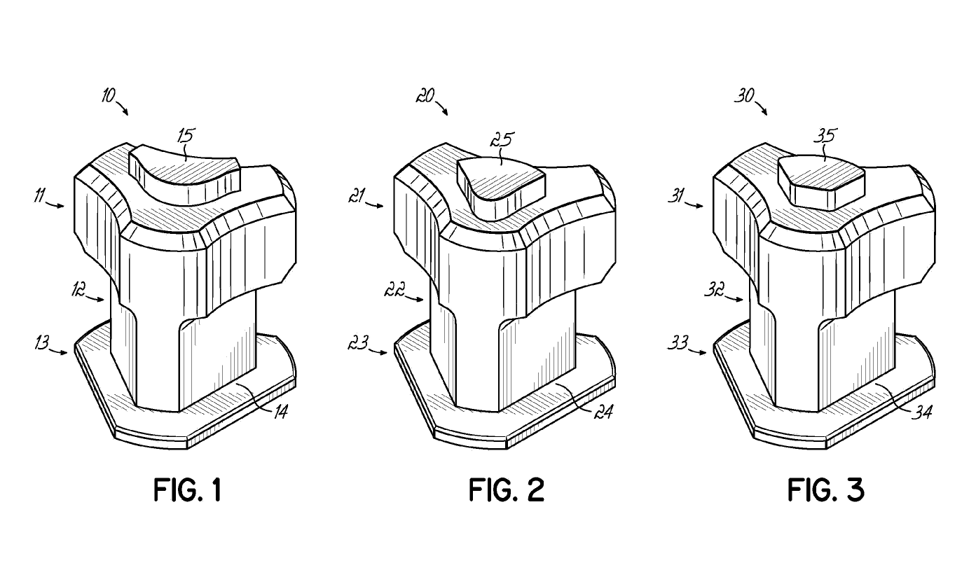

FIG. 1 shows in a first embodiment of the invention an anti-skid stud 10 consisting of a support body part 14 and a pin body part 15. The support body part comprises a head portion 11, a middle portion 12 and a bottom portion 13.

The support body part 14 comprises a receptacle with the pin body part 15 inserted into the receptacle and secured to the support body part 14 via press fit. The support body part 14 may be made from aluminum or steel. The pin body part 15 may be made from a commonly used hard ceramic material or hard metal material and extends axially beyond the upper surface of the head portion 11. As shown in FIG. 1, the head portion 11 has a larger size or diameter than the middle portion 12. The bottom portion 13 has also a larger size or diameter than the middle portion 12. The different shape of bottom portion 13, middle portion 12 and head portion 11 makes these parts of the anti-skid stud 10 distinguishable as separate sections of the anti-skid stud 10. The size of the bottom portion 13 may be the same than the size of the head portion 11 or slightly larger, i.e., 5% to 20% larger. The head portion 11 is axially above and adjacent to the middle portion 12. The middle portion 12 is axially above and adjacent to the bottom portion 13.

Besides the shape of the support body part 14 and the pin body part 15, which is further explained below and shown in the figures, the anti-skid stud 10 may correspond to the stud described in WO 2011/036050 A1 or in US 2011/0088822 A1 with regard to general dimensions.

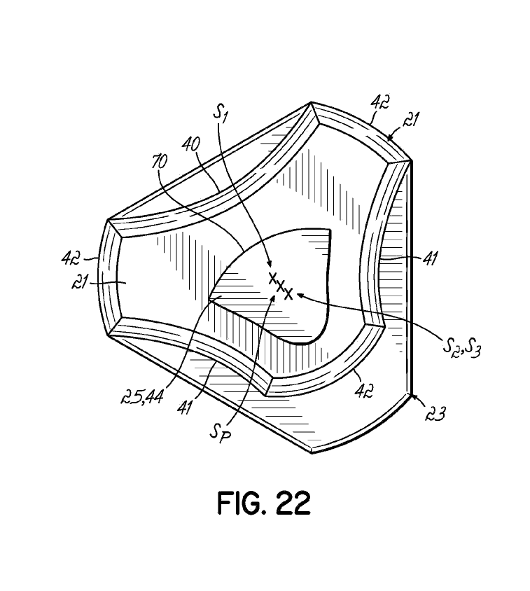

For the anti-skid stud 10 shown in FIG. 1, the location of the center of gravity S₁ of the head portion 11 is laterally offset from the center of gravity S₃ of the bottom portion 13 when viewed in top view onto the head portion 11. This is explained in more detail in FIG. 22. The lateral offset of S₁ with regard to S₃ may be in a range from 0.5 mm to 3.0 mm such as 1.5 mm or from 1.0 mm to 2.0 mm. The location of the center of gravity S₂ of the middle portion 12 is axially aligned with the center of gravity S₃ of the bottom portion 13, i.e. both are at the same location in top view onto the head portion 11. There may however also be a lateral offset in a range of from 0.3 mm to 1.0 mm. The location of the center of gravity Sp of the pin body part 15 is laterally offset from the center of gravity S₃ of the bottom portion 13 when viewed in top view onto the head portion 11. The center of gravity Sp of the pin body part 15 may however also be axially aligned with the center of gravity S₃ of the bottom portion 13, or the center of gravity S₁ of the head portion 11 may be axially aligned with the center of gravity Sp of the pin body part. The lateral offset of Sₚ with regard to S₃ may be in a range from 0.3 to 1.5 mm, such as 0.8 mm, or from 0.5 mm to 1.0 mm.

The bottom portion 13 has, when viewed in top view onto the head portion 11, a substantially hexagonal shape with rounded edges and alternating straight and slightly segment shaped sides. In alternative embodiments, it may also have a substantially triangular shape with or without rounded edges, a symmetrical substantially triangular shape with or without rounded edges, an equilateral triangular shape with or without rounded edges, a substantially hexagonal shape with only straight sides with or without rounded edges, a substantially hexagonal shape with only convex shaped sides with or without rounded edges, a substantially hexagonal shape with only concave shaped sides with or without rounded edges, or a substantially hexagonal shape with alternating convex and concave shaped sides with or without rounded edges.

The pin body part 15 has, when viewed in top view onto the pin body part 11, substantially the shape of a lens with or without rounded edges or the shape of an aspherical lens or an axially symmetrical aspherical lens 43. In alternative embodiments, it may also have substantially the shape of a sector of a circle with or without rounded edges, substantially the shape of a segment of an annulus with or without rounded edges, substantially the shape of a trapezium with or without rounded edges, substantially the shape of a hexagon with or without rounded edges, substantially the shape of a trapezium with or without rounded edges with alternating straight and concave shaped sides, substantially the shape of a trapezium with or without rounded edges with alternating straight and convex shaped sides, substantially the shape of a trapezium with or without rounded edges with alternating concave and convex shaped sides, or substantially the shape of a tetragon with or without rounded edges with straight, concave and convex shaped sides.

The middle portion 12 may mimic, when viewed in top view onto the middle portion 12, the shape of the bottom portion 13 at a reduced size. In general, the middle portion 12 may have, when viewed in top view onto the head portion, a substantially triangular shape with or without rounded edges, a symmetrical substantially triangular shape with or without rounded edges, an equilateral triangular shape with or without rounded edges, a substantially hexagonal shape with or without rounded edges, a substantially hexagonal shape with alternating straight and segment shaped sides with or without rounded edges, a substantially hexagonal shape with only straight sides with or without rounded edges, a substantially hexagonal shape with only convex shaped sides with or without rounded edges, a substantially hexagonal shape with only concave shaped sides with or without rounded edges or a substantially hexagonal shape with alternating convex and concave shaped sides with or without rounded edges.

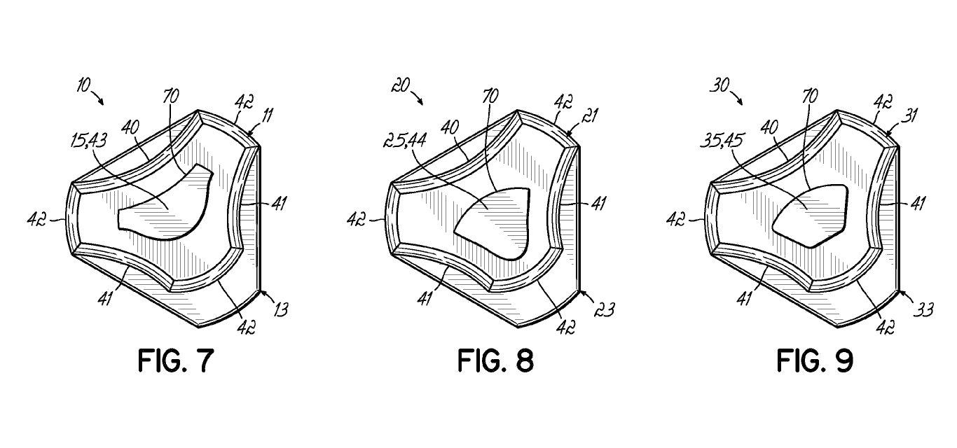

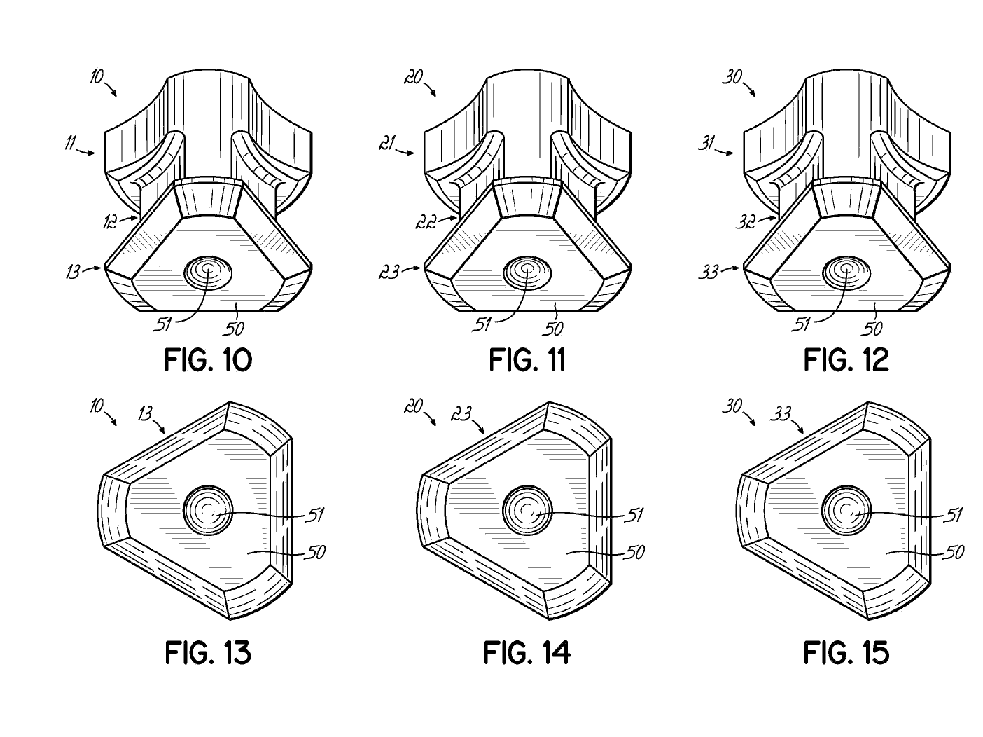

The head portion 11 in FIG. 1 has, in top view onto the head portion 11, a substantially hexagonal shape with alternating convex and concave shaped sides with rounded edges. FIG. 7 shows the leading edge 70 of the pin body 10, a long convex shaped side 40 of the head portion 11, two shorter convex shaped sides 41 of the head portion 11 of the same length and shape, and three concave shaped sides 42 of the head portion 11 of the same length and shape. The head portion 11 may have a chamfered upper and/or lower outline, as shown in FIGS. 1 and 3. The bottom portion may also have a chamfered lower outline as shown in FIGS. 10 and 13.

In alternative embodiments, the head portion 11 may also have a substantially triangular shape with or without rounded edges, an isosceles triangular shape with or without rounded edges, a substantially hexagonal shape with or without rounded edges, a substantially hexagonal shape with alternating straight and segment shaped sides with or without rounded edges, a substantially hexagonal shape with only straight sides with or without rounded edges, a substantially hexagonal shape with only convex shaped sides with or without rounded edges or a substantially hexagonal shape with only concave shaped sides with or without rounded edges.

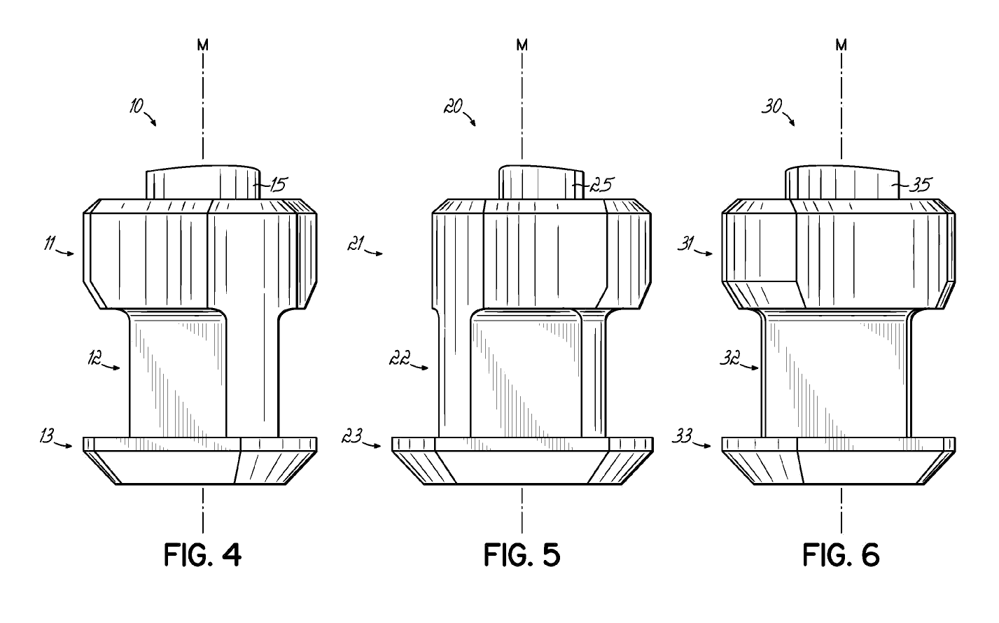

FIG. 4 shows a side view of FIG. 1 indicating an axial direction M. FIG. 7 shows a top view of FIG. 1. FIG. 10 is a perspective view from the bottom side of FIG. 1. FIG. 13 is a bottom view of FIG. 1. FIG. 13 shows the underside 50 of the anti-skid stud 10 with a recess 51 having the shape of a hemisphere or similar.

FIG. 2 shows in a second embodiment of the invention an anti-skid stud 20 consisting of a support body part 24 and a pin body part 25. The support body part comprises a head portion 21, a middle portion 22 and a bottom portion 23.

FIG. 5 shows a side view of FIG. 2. FIG. 8 shows a top view of FIG. 2. FIG. 11 shows a perspective view from the bottom side of FIG. 2. FIG. 14 is a bottom view of FIG. 2 showing the underside 50 of the anti-skid stud 20 comprising a recess 51 having the shape of a hemisphere.

Besides the shape of the pin body 25, the shape, dimensions and materials of the anti-skid stud 20 may be the same as the anti-skid body 10. The pin body 25 has substantially the shape of a sector 44 of a circle with rounded edges with two concave shaped sides of the same length and shape, one longer convex shaped side and one opposite shorter convex side (which may also be called a rounded edge).

FIG. 3 shows in a third embodiment of the invention an anti-skid stud 30 consisting of a support body part 34 and a pin body part 35. The support body part comprises a head portion 31, a middle portion 32 and a bottom portion 33.

FIG. 6 shows a side view of FIG. 3. FIG. 9 shows a top view of FIG. 3. FIG. 12 is a perspective view from the bottom side of FIG. 3. FIG. 15 is a bottom view of FIG. 3 showing the underside 50 of the anti-skid stud 20 comprising a recess 51 having the shape of an hemisphere.

Besides the shape of the pin body 35, the shape, dimensions and materials of the anti-skid stud 30 again may be the same as the anti-skid body 10. The pin body 35 has substantially the shape of an annulus 45 with rounded edges with one straight line, two concave sides of the same length and shape and one convex side opposite the straight line. The shape of the pin body 35 may also have substantially the shape of a trapezium with rounded edges or having the shape of a tetragon without slightly rounded edges with one straight, two concave and one convex shaped side.

In alternative embodiments of FIG. 7, 8 or 9, the pin body 15, 25, 35, when viewed in top view onto the pin body, may also have substantially the shape of a segment of an annulus with or without rounded edges, substantially the shape of a trapezium with or without rounded edges, substantially the shape of a hexagon with or without rounded edges, substantially the shape of a trapezium with or without rounded edges with alternating straight and concave shaped sides, substantially the shape of a trapezium with or without rounded edges with alternating straight and convex shaped sides, substantially the shape of a trapezium with or without rounded edges with alternating concave and convex shaped sides, or substantially the shape of a tetragon with or without rounded edges with straight, concave and convex shaped sides.

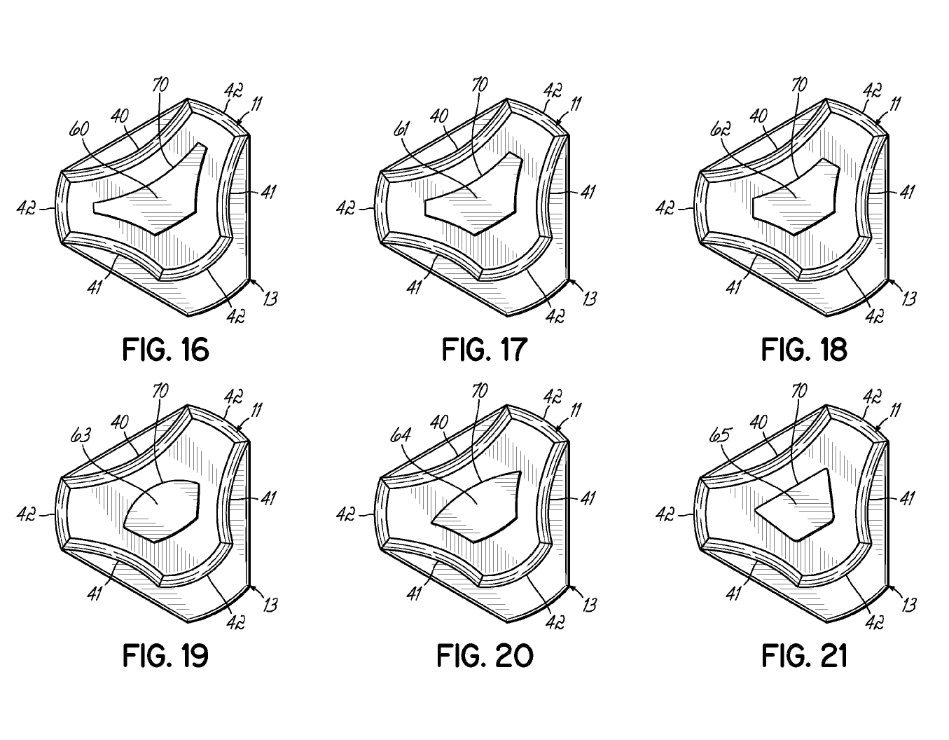

FIGS. 16 to 21 show further embodiments in accordance with the present invention with further alternative shapes of the pin body in top view onto the respective pin body or the respective anti-skid stud. Besides the shape of the respective pin body, the shapes, dimensions and materials of the anti-skid studs of FIGS. 16 to 21 may be are the same than the anti-skid body 10 shown in FIGS. 1, 4, 7, 10 and 13. FIGS. 16 to 21 also show the leadings edges 70 of the respective pin body parts with their various lengths and shapes as well as the respective pin body parts being either basically hexagonal or trapezoidal shaped pin body parts 60, 61, 62, or basically tetragonal shaped pin body parts 63, 64, 65.

The surface area of the pin body parts 15, 25, 35, 60, 61, 62, 63, 64, 65, when viewed in top view of the respective pin body part, may be in the range of from 4.5 mm² to 7.0 mm², alternatively from 5.0 mm² to 6.5 mm².

The leading edge 70 of the respective pin body part 15, 25, 35, 60, 61, 62, 63, 64, 65 has a length in a range of from 3.0 mm to 7.5 mm, alternatively from 3.0 mm to 5.5 mm or from 3.0 to 4.5 mm. The leading edge 70 may be oriented perpendicular or at least substantially perpendicular to the rolling direction of the tire.

The anti-skid studs in accordance with the present invention are particularly suitable for oriented use in a tire tread. In such a tread, the majority of the anti-skid studs or even all or about all the anti-skid studs are oriented in a common direction with the leading edges of the oriented anti-skid studs being at least substantially oriented in a direction perpendicular to the rolling direction of the tire.

FIG. 22 shows, for the embodiment of FIGS. 2 and 8, the location of the center of gravity S₁ of the head portion 11, the location of the center of gravity S₃ of the bottom portion 13, the location of the center of gravity S₂ of the middle portion 12, and the location of the center of gravity Sp of the pin body part 15 when viewed in top view of the anti-skid stud 10 and when projecting these centers of gravity into the surface of the pin body part 15 or the head portion 11 respectively. This plane is perpendicular to the axial direction M extending along the length of the anti-skid stud 10. In the embodiment of FIG. 22, the centers of gravity S₁, S₂, S₃, Sₚ are all located on one straight line coincident with S₂ and S₃. The respective location of the centers of gravity S₁, S₂, S₃, Sₚ for the other embodiments described in this application is basically similar however with the location of Sₚ moving with the variation of the shape of the respective pin body.

The embodiments shown in FIGS. 1-22 may also be described showing anti-skid studs for insertion into the tread or the use with the tread of a vehicle tire, wherein, when rotating the support body part about an axis extending along the axial direction and through the center of gravity of the anti-skid stud or at least of the head portion of the anti-skid stud, the rotated anti-skid stud is congruent with the respective unrotated anti-skid stud only when the anti-skid stud is rotated by 360 degrees, i.e., no axial symmetry of the anti-skid stud along said axis and the rotated anti-skid stud matching itself (but unrotated) only when rotated by 360 degrees.

The design of the pin body part together with the design of the support body part, when used as oriented studs in a tread of a tire such as a radial passenger or SUV tire, provides improved grip on icy roads compared to conventional studs such as those described in WO 2011/036050 A1. Due to the design of the head portion of the support body, the pin body part may be designed to have a relatively long and pronounced leading edge.

The anti-skid stud 10, 20, 30 in accordance with the present invention having a head portion 11, 21, 31 with three convex shaped sides 40, 41 (with concave or otherwise shaped sides or edges in between) as shown in FIGS. 1-22 also allow the respective studs to be easily and reliably oriented when inserting the studs into a tire tread. Conventional machines for studding tires may have three fingers at their gun head which are arranged similar to the three fingers of common drill chucks gripping the borer in drilling machines. The fingers in the gun head of studding machines are in cross section oval or round, i.e., the design of the head portion 11, 21, 31 of the anti-skid studs 10, 20, 30 and the convex shape of the sides 40, 41 and their number may be such that it fits to the design and arrangement of these fingers. This allows it to grip the studs in a reliable way such that, once gripped by the fingers of the respective studding machine, the studs may later rotate before or while being inserted into a tire tread. Furthermore, the anti-skid studs in conventional studding machines are usually supplied to the gripping fingers at the end of the chuck or gun head of the studding machine through a pipe or channel extending coaxially through the chuck or gun head of the studding machine with this pipe of channel ending between the gripping fingers. The cross-section of this pipe or channel may now be adapted to the cross-section of the anti-skid studs supplied to the studding machine and in particular to the cross-section of the bottom portion 13, 23, 33 of the anti-skid studs so that the studs moving through this pipe of channel of the studding machine have already an orientation as required for achieving a wanted orientation of the studs after insertion into a tire tread. This orientation is kept when the studs are gripped by the finger of the studding machine before and while the stud is inserted into a respective hole in a tire tread. Hence, the design of the studs in accordance with the present invention ensures that the studs are kept in the desired orientation and do not twist during the studding process even when using conventional studding machines.

What is claimed is:

1. An anti-skid stud for insertion into the tread of a vehicle tire, the stud comprising a support body part extending in an axial direction and a pin body part, the support body part comprising a bottom portion, a middle portion, and a head portion having an upper surface, wherein the pin body part extends beyond the upper surface of the head portion, wherein, when viewed in top view onto the head portion,
(i) the location of the center of gravity of the head portion is laterally offset from the center of gravity of the bottom portion; or
(ii) the location of the center of gravity of the pin body part is laterally offset from the center of gravity of the bottom portion; or
(iii) the location of the center of gravity of the pin body part is laterally offset from the center of gravity of the head portion; or
(iv) the location of the center of gravity of the middle portion is laterally offset from the center of gravity of the bottom portion.

2. The anti-skid stud of claim 1 wherein the location of the center of gravity of the head portion is laterally offset from the center of gravity of the bottom portion, and wherein the location of the center of gravity of the pin body part is laterally offset from the center of gravity of the bottom portion.

3. The anti-skid stud of claim 1 wherein the location of the center of gravity of the head portion is laterally offset from the center of gravity of the bottom portion, and wherein the location of the center of gravity of the pin body part is laterally offset from the center of gravity of the head portion.

4. The anti-skid stud of claim 1 wherein the location of the center of gravity of the pin body part is laterally offset from the center of gravity of the bottom portion and wherein the location of the center of gravity of the pin body part is laterally offset from the center of gravity of the head portion.

5. The anti-skid stud of claim 1 wherein the bottom portion has, when viewed in top view onto the head portion:
(i) a substantially triangular shape with or without rounded edges;
(ii) a symmetrical substantially triangular shape with or without rounded edges;
(iii) an equilateral triangular shape with or without rounded edges;
(iv) a substantially hexagonal shape with or without rounded edges;
(v) a substantially hexagonal shape with alternating straight and segment shaped sides with or without rounded edges;
(vi) a substantially hexagonal shape with only straight sides with or without rounded edges;
(vii) a substantially hexagonal shape with only convex shaped sides with or without rounded edges;
(viii) a substantially hexagonal shape with only concave shaped sides with or without rounded edges; or
(ix) a substantially hexagonal shape with alternating convex and concave shaped sides with or without rounded edges.

6. The anti-skid stud of claim 1 wherein the middle portion has, when viewed in top view onto the head portion:
(i) a substantially triangular shape with or without rounded edges;
(ii) a symmetrical substantially triangular shape with or without rounded edges;
(iii) an equilateral triangular shape with or without rounded edges;
(iv) a substantially hexagonal shape with or without rounded edges;
(v) a substantially hexagonal shape with alternating straight and segment shaped sides with or without rounded edges;
(vi) a substantially hexagonal shape with only straight sides with or without rounded edges;
(vii) a substantially hexagonal shape with only convex shaped sides with or without rounded edges;
(viii) a substantially hexagonal shape with only concave shaped sides with or without rounded edges; or
(ix) a substantially hexagonal shape with alternating convex and concave shaped sides with or without rounded edges.

7. The anti-skid stud of claim 1 wherein the middle portion mimics, when viewed in top view onto the middle portion, the shape of the bottom portion at a reduced size.

8. The anti-skid stud of claim 1 wherein the head portion has, when viewed in top view onto the head portion:
(i) a substantially triangular shape with or without rounded edges;
(ii) an isosceles triangular shape with or without rounded edges;
(iii) a substantially hexagonal shape with or without rounded edges;
(iv) a substantially hexagonal shape with alternating straight and segment shaped sides with or without rounded edges;
(v) a substantially hexagonal shape with only straight sides with or without rounded edges;
(vi) a substantially hexagonal shape with only convex shaped sides with or without rounded edges;
(vii) a substantially hexagonal shape with only concave shaped sides with or without rounded edges; or
(viii) a substantially hexagonal shape with alternating convex and concave shaped sides with or without rounded edges.

9. The anti-skid stud of claim 8 wherein the convex shaped sides are longer than the concave shaped sides.

10. The anti-skid stud of claim 8 wherein, when viewed in top view onto the head portion, the head portion has
(i) a substantially hexagonal shape with alternating convex and concave shaped sides, wherein the two of the three convex shaped sides have the same length or about the same length and the third convex shaped side has a greater length than the other two convex shaped sides; or
(ii) a substantially hexagonal shape with alternating convex and concave shaped sides, wherein the three concave shaped sides have the same length or about the same length; or
(iii) a substantially hexagonal shape with alternating convex and concave shaped sides, wherein the three convex shaped sides have the same length or about the same length; or
(iv) a substantially hexagonal shape with alternating convex and concave shaped sides, wherein the two of the three concave shaped sides have the same length or about the same length and the third concave shaped side has a greater length than the other two concave shaped sides;
(v) a substantially hexagonal shape with alternating convex and concave shaped sides, and wherein two of the three convex shaped sides have the same length or about the same length and the third convex shaped side has a greater length than the other two convex shaped sides.

11. The anti-skid stud of claim 10 wherein in option (iv) the third concave shaped side is located opposite the longest convex shaped side.

12. The anti-skid stud of claim 10 wherein in option (v) the third convex shaped side is located opposite the longest concave shaped side.

13. The anti-skid stud of claim 1 wherein the pin body part has, when viewed in top view onto the pin body part:
(i) substantially the shape of a sector of a circle with or without rounded edges;
(ii) substantially the shape of a lens with or without rounded edges;
(iii) substantially the shape of an aspherical lens or an axially symmetrical aspherical lens;
(iv) substantially the shape of a segment of an annulus with or without rounded edges;
(v) substantially the shape of a trapezium with or without rounded edges;
(vi) substantially the shape of a hexagon with or without rounded edges;
(vii) substantially the shape of a trapezium with or without rounded edges with alternating straight and concave shaped sides;
(viii) substantially the shape of a trapezium with or without rounded edges with alternating straight and convex shaped sides
(ix) substantially the shape of a trapezium with or without rounded edges with alternating concave and convex shaped sides
(x) substantially the shape of a tetragon with or without rounded edges with straight, concave and convex shaped sides.

14. The anti-skid stud of claim 13 wherein in option (ii) or (iii) the lens comprises an at least substantially convex side and an at least substantially concave opposite side.

15. The anti-skid stud of claim 1 wherein, when viewed in top view onto the pin body part, the pin body part mimics the shape of the head portion at a reduced size.

16. The anti-skid stud of claim 1 wherein the surface area of the pin body part, when viewed in top view onto the pin body part, is in the range of from 4.5 mm² to 7 mm², alternatively of from 5.0 mm² to 6.5 mm².

17. The anti-skid stud of claim 1 wherein the pin body part comprises a leading edge having a length in a range of from 3 to 7.5 mm, alternatively from 3 to 5.5 mm or from 3 to 4.5 mm.

18. An anti-skid stud for insertion into the tread of a vehicle tire, the stud comprising a support body part extending in an axial direction and a pin body part, the support body part comprising a bottom portion, a middle portion, and a head portion having an upper surface, wherein the pin body part extends beyond the upper surface of the head portion, and wherein, when rotating the support body part about an axis extending along the axial direction and through the center of gravity of the anti-skid stud, the rotated anti-skid stud is congruent with the respective unrotated anti-skid stud only when the anti-skid stud is rotated by 360 degrees.

19. A pneumatic tire comprising a tread, the tread comprising a plurality of anti-skid studs, each of the studs comprising a support body part extending in an axial direction and a pin body part, the support body part comprising a bottom portion, a middle portion, and a head portion having an upper surface, wherein the pin body part extends beyond the upper surface of the head portion, wherein
(A) when viewed in top view onto the head portion,
(i) the location of the center of gravity of the head portion is laterally offset from the center of gravity of the bottom portion; or
(ii) the location of the center of gravity of the pin body part is laterally offset from the center of gravity of the bottom portion; or
(iii) the location of the center of gravity of the pin body part is laterally offset from the center of gravity of the head portion; or
(iv) the location of the center of gravity of the middle portion is laterally offset from the center of gravity of the bottom portion; or wherein
(B) when rotating the support body part about an axis extending along the axial direction and through the center of gravity of the anti-skid stud, the rotated anti-skid stud is congruent with the respective unrotated anti-skid stud only when the anti-skid stud is rotated by 360 degrees.

20. The tire of claim 19 wherein the majority of the anti-skid studs or more than 90% of the anti-skid studs is oriented in a common direction with leading edges of the oriented anti-skid studs being at least substantially oriented in a direction perpendicular to the rolling direction of the tire.
